(19) United States
(12) Patent Application Publication
(10) Pub. No.: US 2010/0051696 A1
(43) Pub. Date: Mar. 4, 2010

(54) ILLUMINATION SYSTEM FOR A BAR CODE READER

(75) Inventors: Rong Liu, Selden, NY (US); Wynn Aker, Manorville, NY (US); Igor Vinogradov, New York, NY (US)

Correspondence Address: MOTOROLA, INC., 1303 EAST ALGONQUIN ROAD, IL01/3RD, SCHAUMBURG, IL, 60196, US

(73) Assignee: Symbol Technologies, Inc., Holtsville, NY (US)

(21) Appl. No.: 12/199,110

(22) Filed: Aug. 27, 2008

(51) Int. Cl. G06K 7/10

(52) U.S. Cl. 235/462.42

(57) ABSTRACT

A method and apparatus for illuminating a target object such as a bar code having areas of differing light intensity on the target. A bar code reader has a light source that is selectively activated, a screen having a slit aperture for creating a narrow light beam, a reflecting mirror for reflecting light transmitted through the slit aperture and a lens for shaping light reflected by the mirror to form an elongated target/illumination pattern.

### FIELD OF THE INVENTION

The present invention relates to an illumination system for a bar code reader and, more particularly, to an illumination system for creating a visible aiming target on an object.

### BACKGROUND ART

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Code 39, primarily used in inventory tracking; and Postnet, which is used for encoding zip codes for U.S. mail. Systems that read and decode bar codes employing charged coupled device (CCD) or complementary metal oxide semiconductor (CMOS) based imaging systems are typically referred to hereinafter as imaging-based bar code readers.

Bar code readers electro-optically transform the graphic indicia of the bar code into electrical signals, which are decoded into alphanumerical characters that are descriptive of the article containing the bar code. The characters are then typically represented in digital form and utilized as an input to a data processing system for various end-user applications such as point-of-sale processing, inventory control and the like.

Imaging systems used in bar code readers include charge coupled device (CCD) arrays, complementary metal oxide semiconductor (CMOS) arrays, or other imaging pixel arrays having a plurality of photosensitive elements (photosensors) or pixel array. An illumination system directs illumination toward a target object, e.g., a target bar code and light reflected from the target bar code is focused through a lens of the imaging system onto the pixel array.

Imaging-based bar code readers typically employ an illumination system to flood a target object with illumination from a light source such as a light emitting diode (LED) in the reader. Light from the light source or LED is reflected from the target object. The reflected light is then focused through a lens of the imaging system onto a two dimensional pixel array. In a linear imaging bar code reader, the sensor array is much wider in one dimension than another. The sensor array can capture a wide (few inches) field of view that is very narrow (one or only a few pixels) in an orthogonal direction so that only a narrow strip of pixels is captured by the reader.

Bar code readers often have an illumination system that facilitates aiming the bar code reader. One challenge in designing bar code readers is a way to provide simple and cost effective illumination optics to generate a sharp illumination/aiming scan line having brightness without substantial loss due to coupling efficiency between the light source and a lens element that transmits light from the source to a target object. Published U.S. patent application US 2008/0156876 to Vinogradov discloses an illumination system and a focusing lens to generate an illumination pattern. The disclosure of this application is incorporated herein by reference in its entirety.

### SUMMARY

The present disclosure is directed to a bar code reading having an illumination system for generating an illumination/aiming pattern and has particular utility for use with a linear imaging bar code reader.

A representative system has a fold mirror with an optical power that is unequal in orthogonal directions for matching the emitting angle of a light source to the numerical aperture of an illumination lens. In addition, the illumination lens has an aspherical toroidal surface, which allows it to yield more uniform illumination along the scan line with brighter light intensity at the edges of a scan line for better perception of the scan line by the user.

These and other objects, advantages, and features of the exemplary embodiments are described in detail in conjunction with the accompanying drawings.

### BRIEF DESCRIPTION OF THE DRAWINGS

FIG. 1 is a schematic side elevation view of an exemplary embodiment of an imaging-based bar code reader;

FIG. 2 is a schematic front elevation view of the bar code reader of FIG. 1;

FIG. 3 is a schematic view of an imaging assembly of the bar code reader of FIG. 1;

FIG. 4 is a depiction of light from a source generating a target or aiming pattern within a field of view of a bar code reader;

FIG. 5 is a top plan depiction of the apparatus of FIG. 4;

FIG. 6 is a schematic depiction of a source, aperture, positive and negative lens for creating an illumination/aiming pattern; and

FIG. 7 is a schematic perspective view of an exemplary illumination system for use with a bar code reader.

### DETAILED DESCRIPTION

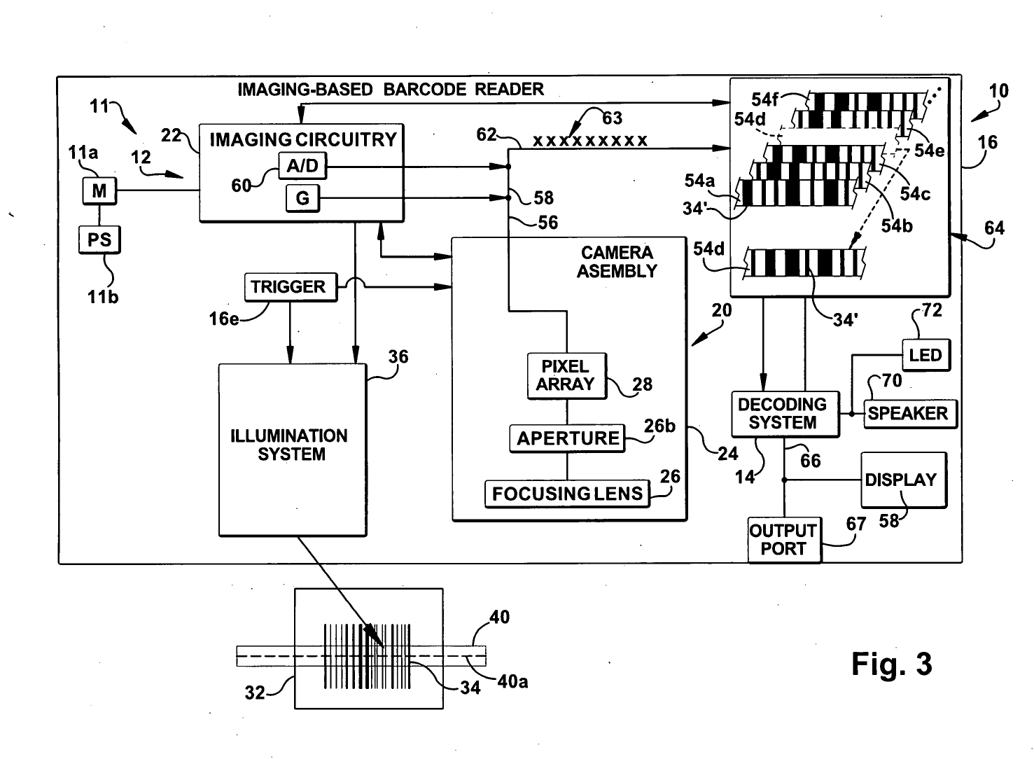

An exemplary embodiment of an imaging-based bar code reader of the present invention is shown schematically at 10 in the Figures. The bar code reader 10 includes an imaging system 12 (FIG. 3) and a decoding system 14 supported in a housing 16. The imaging and decoding systems 12, 14 are capable of reading, that is, imaging and decoding both 1D and 2D bar codes and postal codes. The present disclosure emphasizes a reader 10 that reads 1D bar codes 34 affixed to a target object 32. Such a reader 10 is configured as a linear imager for capturing only a narrow pixel array.

The decoding system 14 is adapted to decode encoded indicia within a selected captured image frame. The housing 16 supports reader circuitry 11 within an interior region 17 of the housing 16. The reader circuitry 11 includes a microprocessor 11a and a power supply 11b. The power supply 11b is electrically coupled to and provides power to the circuitry 11. The housing 16 also supports the imaging and decoding systems 12, 14 within the housing's interior region 17. The depicted reader 10 includes a docking station 30 adapted to receive the housing 16. The docking station 30 and the housing 16 support an electrical interface to allow electric coupling between circuitry resident in the housing 16 and circuitry resident in the docking station 30.

The imaging and decoding systems 12, 14 operate under the control of the microprocessor 11a. The imaging and decoding systems 12, 14 may be separate assemblies which are electrically coupled or may be integrated into a single imaging and decoding system. When removed from the docking station 30 of the reader 10, power is supplied to the imaging and decoding systems 12, 14 by the power supply 11b. The circuitry of the imaging and decoding systems 12, 14 may be embodied in hardware, software, firmware or electrical circuitry or any combination thereof. Moreover, portions of the circuitry 11 may be resident in the housing 16 or the docking station 30.

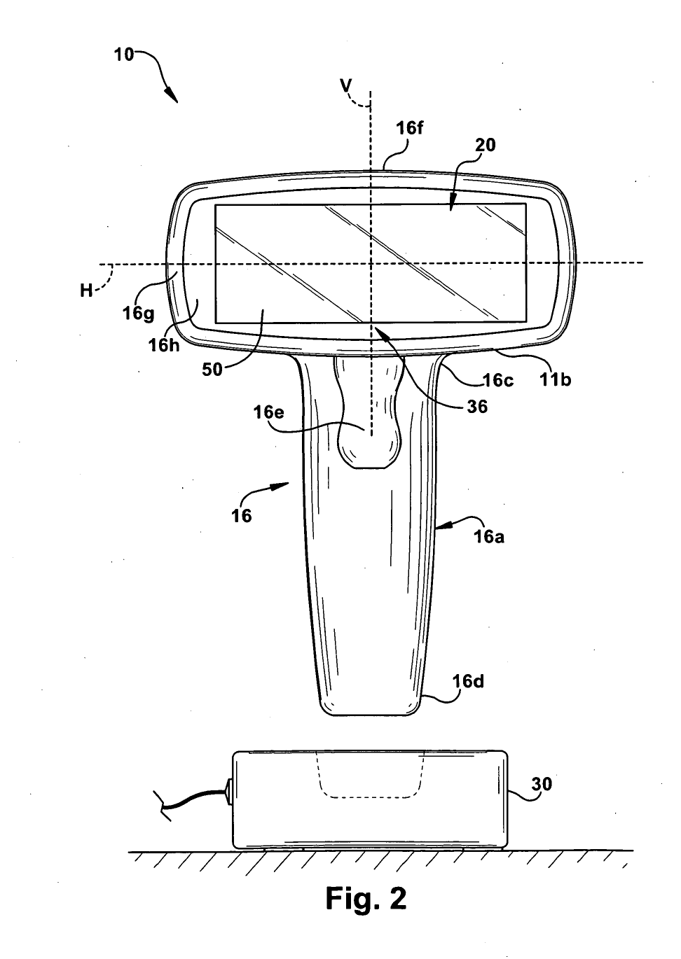

In a hand-held or point-and-shoot mode of operation (FIG. 2), the reader 10 is carried and operated by a user walking or riding through a store, warehouse or plant for reading target bar codes for stocking and inventory control purposes. In the hand-held mode, the housing 16 is removed from a docking station 30 so the reader 10 can be carried by the user. The user grasps a housing gripping portion 16 a and positions the housing 16 with respect to the target bar code 34 such that the target bar code is within a field of view of the imaging system 12.

In the hand-held mode, imaging and decoding of the target bar code 34 is instituted by the user depressing a trigger switch 16e which extends through an opening near the upper part 16c of the gripping portion 16a. When the trigger 16e is depressed, the imaging system 12 generates a series of image frames (54a-54f for example) until either the user releases the trigger 16e, an image 34′ of one frame (54d for example) the target bar code 34 has been successfully decoded or a predetermined period of time elapses, whereupon the imaging system 12 awaits a new trigger signal.

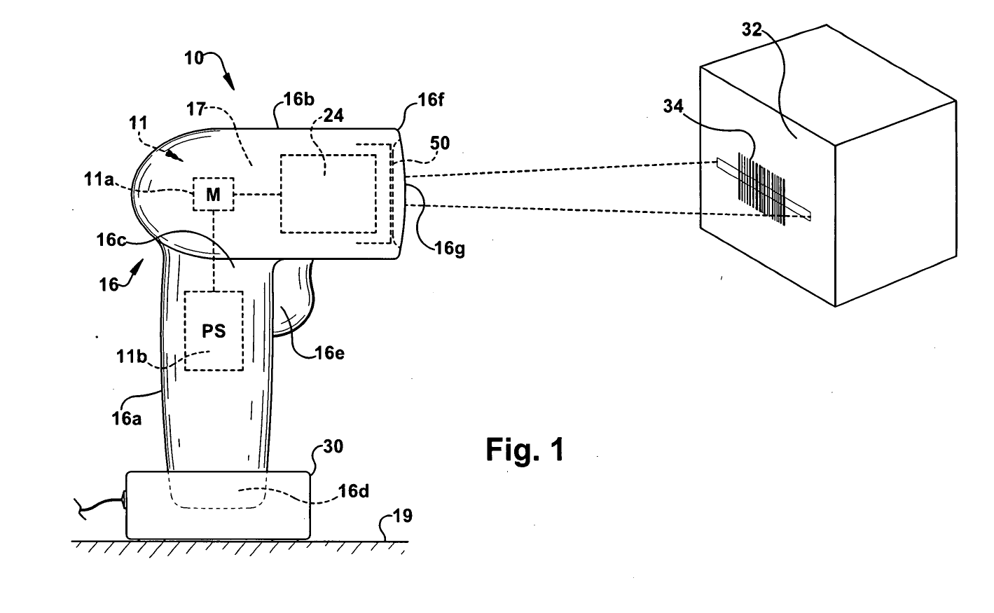

In a fixed position or hands-free mode (FIG. 1), the reader 10 is received in the docking station 30 which is positioned on a substrate, such as a table or counter 19. The docking station 30 is plugged into an AC power source and provides regulated DC power to the circuitry 11 of the reader 10. The bar code reader 10 includes an illumination system 36 to illuminate the target bar code 34 with an illumination/aiming light pattern 40. The illumination system 36 typically includes one or more illumination LEDs 38 which are energized to direct illumination light to a reflecting mirror 42 which reflects light through a lens 44 to the bar code to form the illumination/aiming pattern 40 which can be aligned by the user with respect to the bar code 34. A center line 40a of the target pattern 40 from the illumination system 36 can be moved from side to side and up and down as the user manipulates the scanner.

The aiming pattern forms a line of illumination having a width W and length L. When imaging a 2D bar code, the reader uses a sensor having a large number of pixels in two orthogonal directions. The aiming pattern could have use with a raster scanner bar code reader as well. This construction using a light source with an oscillating mirror that scans vertically across a bar code. The aiming pattern may distort the imaged bar code and complicate the decoding of the imaged bar code so that the aiming system may be intermittently energized in a flash mode such that at least some of the captured image frames 54a-54f do not include an image of the aiming pattern 40.

The imaging system 12 has an imaging camera assembly 20 and associated imaging circuitry 22. The imaging camera 20 includes a housing 24 supporting focusing optics including a focusing lens 26 and a sensor or pixel array 28. The sensor array 28 is enabled during an exposure period to capture image pixels. The field of view of the imaging system 12 is a function of both the configuration of the sensor array 28 and the optical characteristics of the focusing lens 26. For a linear imager, the field of view is a narrow swatch of pixels in one direction, possible only one pixel wide.

The camera housing 24 is positioned within an interior region 17 of the scanning head 16b. The housing 24 is in proximity to a transparent window 50 defining a portion of a front wall 16h of the housing scanning head 16b. Reflected light from the target bar code 34 passes through the transparent window 50, is received by the focusing lens 26 and focused onto the imaging system sensor array 28.

In an exemplary embodiment, the illumination assembly 36 of the LED 38 and the mirror 42 are positioned behind the window 50. Illumination from the illumination LED 38 and an aiming pattern also pass through the window 50.

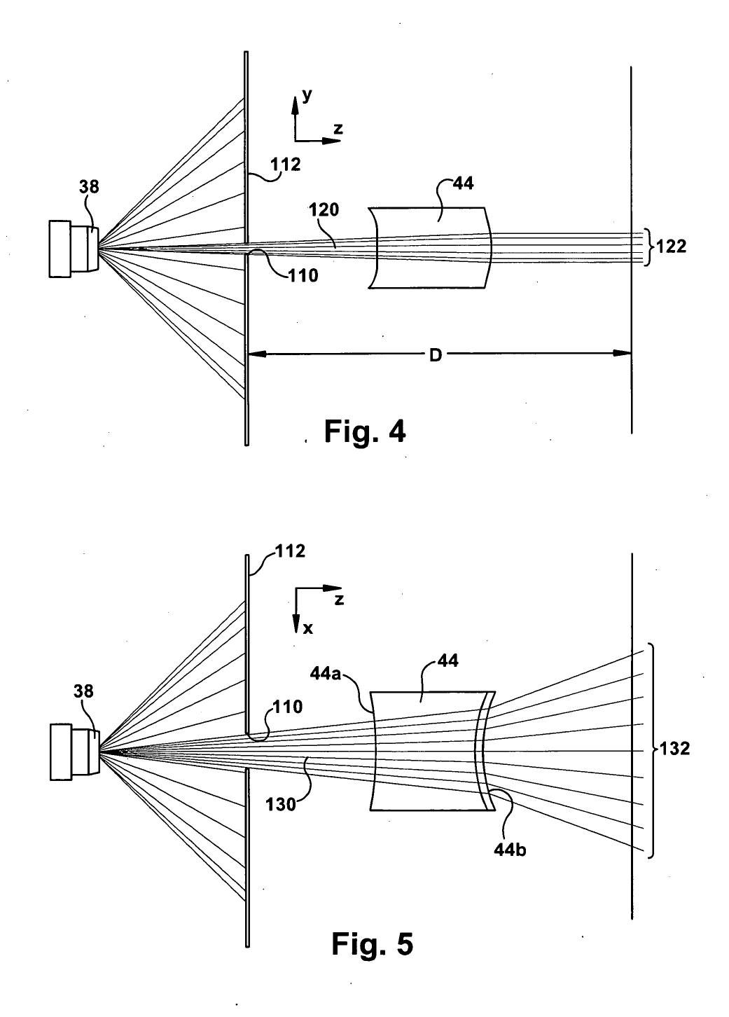

The imaging system 12 includes the sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In the hand-held mode of operation, (possibly aided by the aiming system), the user points the housing 16 at the target bar code 34 and, assuming the target bar code 34 is within the field of view FV of the imaging module 12, each image frame 54a, 54b, 54c, . . . of the series of image frames 54 includes an image 34′ of the target bar code 34 (shown schematically in FIG. 4). The decoding system 14 selects an image frame from the series of image frames 54 and attempts to locate and decode a digitized version of the image bar code 34′.

Electrical signals are generated by reading out some or all of the pixels of the pixel array 28 after an exposure period generating an analog signal 56 (FIG. 3).

The analog image signal 56 represents a sequence of photosensor voltage values, the magnitude of each value representing an intensity of the reflected light received by a photosensor/pixel during an exposure period. The analog signal 46 is amplified by a gain factor, generating an amplified analog signal 58. The imaging circuitry 22 further includes an analog-to-digital (A/D) converter 60. The amplified analog signal 58 is digitized by the A/D converter 60 generating a digitized signal 62. The digitized signal 62 comprises a sequence of digital gray scale values 63 typically ranging from 0-255 (for an eight bit A/D converter, i.e., 2⁸=256), where a 0 gray scale value would represent an absence of any reflected light received by a pixel during an exposure or integration period (characterized as low pixel brightness) and a 255 gray scale value would represent a very intense level of reflected light received by a pixel during an exposure period (characterized as high pixel brightness).

The digitized gray scale values 63 of the digitized signal 62 are stored in a memory 64. The digital values 63 corresponding to a read out of the pixel array 28 constitute the image frame 54, which is representative of the image projected by the focusing lens 26 onto the pixel array 28 during an exposure period. If the field of view FOV of the imaging assembly 24 includes the target bar code 34, then a digital gray scale value image 14′ of the target bar code 34 would be present in the image frame 54.

The decoding circuitry 14 then operates on the digitized gray scale values 63 of the image frame 54 and attempts to decode any decodable image within the image frame, e.g., the imaged target bar code 14′. If the decoding is successful, decoded data 66, representative of the data/information coded in the bar code 34 is then output via a data output port 67 and/or displayed to a user of the reader 10 via a display 68. Upon achieving a good “read” of the bar code 34, that is, the bar code 34 was successfully imaged and decoded, a speaker 70 and/or an indicator LED 72 is activated by the bar code reader circuitry 13 to indicate to the user that the target bar code 14 has successfully read, that is, the target bar code 34 has been successfully imaged and decoded.

### Aiming Pattern

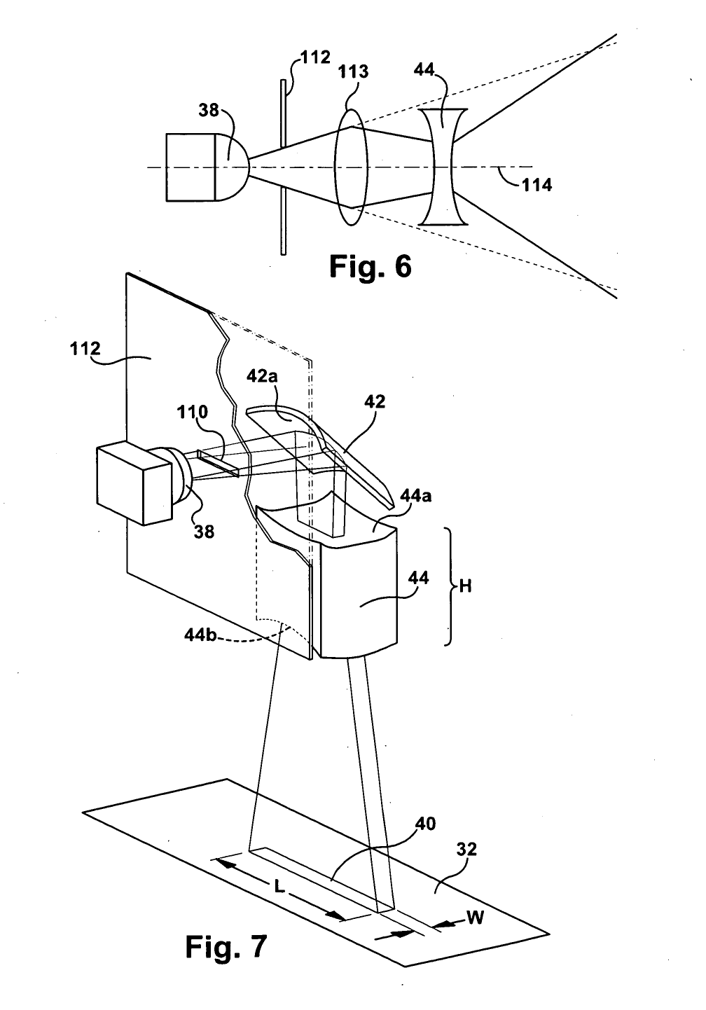

FIGS. 6 and 7 illustrate use of a curved mirror 42, light source such an LED 38 and lens 44 for creating a rectangular aiming pattern 40. The illumination system 36 of FIGS. 4 and 5 have no mirror and show an image of a slit aperture 110 of a screen 112 and projected into the far field using a lens 44 with curvatures in tangential (vertical or y direction as seen in FIG. 4) and sagittal (x-z) planes to create a slit-like illumination pattern 40 within a reader field of view focused at a distance D from the screen 112. The lens 44 is configured to focus diverging light 120 (FIG. 4) from the narrow side of the slit in the tangential direction, thus creating small y-spot radius with small y-field of view to cover the vertical field of view of an imager assembly 24 having a sensor only one or a few pixels wide. It is desired that the lens 44 be as far away as possible from the aperture 110 to match the numerical aperture of the lens to the width of the aperture to maximize the light throughput.

The diverging light 130 (FIG. 5) emitted from the long side of the slit aperture is further diverged (in the x direction) and optimized to provide uniform, and wide angle illumination 132 to match the imaging field of view for different size barcodes. Since the width of the beam is greater, this means that the clear aperture of the lens also needs to be larger, and the resulting size of the lens is not compact and typically will not conform to mechanical constraints of a typical bar code reader.

An alternate approach is to use a shorter focal distance in the saggital direction but this would imply that the lens needs to move closer to the aperture or a substantially thick lens is used. Unfortunately, moving the lens 44 closer to the screen 112 contradicts the requirement for the tangential case that a a longer focal length is desired, and making the lens thick (typically tapered) would either create total internal reflections within the lens element itself that corrupt the angular spread and the uniformity of the illumination pattern, or make the entrance face too small so much of the light is truncated and lost.

The exemplary system depicted in FIG. 7 has a mirror 42 that is curved in the saggital direction to better match the numerical aperture of the source and constrain its angular extent so that the light throughput is maximized for both the sagittal and tangential direction when projected from the slit 110. This system retains the compactness of the illumination system. The preferred mirror is spherical, aspherical, biconic, toroidal or polynomial. One or more set ups can be integrated together to provide a desired radiant flux (power seen by the solid state detector) or luminous flux (power perceived by the human eye).

Advantages of use of the mirror 42 are depicted in FIG. 6. In that figure a light source 38 such as an LED directs diverging light toward a slit aperture 110. An amount of light passes through the aperture but is still diverging. The positive element 113 focuses light toward a centerline 114. Without this positive element much of the light would be unusable and miss a lens 44, for example, which further bends the light downstream from the positive element.

Returning to FIG. 7, the mirror 42 has a reflecting surface 42a such as a surface coated with a reflective material or a plastic or glass element with features to reflect light by the means of total internal reflection. Light striking the surface 42a is reflected off from the surface at an angle defined by the angle at which it strikes the surface and the shape of the surface. The lens 44 has an entrance surface 44a and an exit surface 44b spaced apart a distance H. The path of a representative light beam is bent in accordance with the shape of these two surfaces where the beam enters and exits the as well as a length L of the lens 44.

In the exemplary embodiment of the disclosure the surface 42a, the surface 44a, and the surface 44b are all toroidal surfaces or they approximate toroidal surfaces. In the embodiment of FIG. 7, the mirror surface 42a is a segment of a cylinder which is a special case of a toroidal surface having a rotation radius of zero.

Toroidal surfaces

Toroidal surfaces are formed by defining a curve in the Y-Z plane, and then rotating this curve about an axis parallel to the y axis (FIG. 4) and intersecting the z axis. Toroids are defined using a base radius of curvature c, in the Y-Z plane, as well as a conic constant k, and polynomial aspheric coefficients. The curve in the Y-Z plane is defined by: (note, rotation radius=0 for cylinder)

$$z = \frac{{cy}^{2}}{1 + \sqrt{1 - ( 1 + k ) {c}^{2}} {y}^{2}} + {a}_{1} {y}^{2} + {a}_{2} {y}^{4} + {a}_{3} {y}^{6} + {a}_{4} {y}^{8} + {a}_{5} {y}^{10} + {a}_{6} {y}^{12} + {a}_{7} {y}^{14}$$

This curve is then rotated about an axis a distance R from the vertex. This distance R is referred to as the radius of rotation, and may be positive or negative. Through suitable choices of the coefficients for this generating curve, the combination of the mirror and the lens can be adjusted to produce a suitable aiming/illumination light pattern at a desired focal length from the reader. One suitable structure has an entrance surface 44a constructed using a radius of curvature=0.0 mm, a rotation radius of 100 mm and a₂=−2.90×10⁻³. The exit surface 44b is constructed using a radius of curvature c of 6.7 mm, a rotation radius of −20 mm, a₄=−2.04×10⁻³. The lens 44 has a height of 2.5 mm, width of 10 mm and thickness of 4.0 mm.

While a preferred embodiment of the invention has been described with a degree of particularity, it is the intent that the invention include all modifications and alterations from the disclosed design falling within the spirit or scope of the appended claims.

We Claim:

1. A bar code reader comprising:
a bar code reader housing having a housing interior;
a light transmitting window which extends across a portion of the housing;
image capturing system positioned relative to the light transmitting window within said housing interior for capturing a bar code image; and
an illumination assembly for emitting an illumination/aiming pattern of light from the housing interior to a bar code target object spaced from the housing comprising:
i) an illumination source energizable to emit light to pass through a region of the scanner housing;
ii) a screen having an elongated slit aperture positioned relative to the illumination source for forming an elongated pattern of light;
iii) a mirror having a curved reflecting surface positioned within the housing to reflect light passing through the slit and to focus the light in at least one direction; and
iv) a lens for transmitting light received from the mirror and cause the light to converge or diverge in certain directions and pass through the light transmitting window of the housing.

2. The bar code reader of claim 1 wherein the lens has an entrance surface and an exit surface for bending light and wherein both said surfaces approximate a toroidal surface.

3. The bar code reader of claim 2 wherein the curved reflecting surface of said mirror approximates a toroidal surface.

4. The bar code reader of claim 2 wherein the curved reflecting surface of said mirror approximates a aspheric or polynomial surface.

5. The bar code reader of claim 3 wherein the curved reflecting surface of said mirror approximates a cylinder.

6. The bar code reader of claim 2 wherein the light from the slit aperture is focused by said mirror to narrow the elongated pattern of light before the band of light enters the entrance surface of the lens.

7. The bar code reader of claim 1 wherein the light source is a light emitting diode.

8. The bar code reader of claim 1 wherein the mirror is oriented to reflect the elongated pattern of light at an angle to maintain a desired distance between the slit and the lens while reducing space occupied by the illumination assembly within said housing interior.

9. The bar code reader of claim 2 wherein the toroidal surfaces of the lens are aspheric.

10. The bar code reader of claim 9 wherein the lens deflects the light of the elongated pattern by different amounts in mutually orthogonal directions.

11. A method of scanning a bar code at a region of interest comprising:
mounting image analysis circuitry within a bar code reader housing for capturing a bar code image;
transmitting light through a slit to create a narrow beam of light having a width less than its length;
positioning a mirror having a curved surface within the scanner housing to reflect and shape the beam of light passing through the slit aperture;
intercepting light reflected from the mirror with a lens having an entrance surface and an exit surface to deflect light by differing amounts in two mutually orthogonal directions;
and
selectively causing light to pass through the slit, bounce off the mirror, and pass through the lens to illuminate a bar code at the region of interest outside the scanner housing for capture by the image analysis circuitry.

12. The method of claim 11 wherein the mirror reflects the light beam at approximately a right angle to increase a path length of light within the housing.

13. The method of claim 11 wherein the mirror focuses the light beam to further narrow said beam of light.

14. The method of claim 11 wherein the lens focuses the light beam in a direction orthogonal to a direction the mirror focuses said light beam.

15. The method of claim 11 wherein the lens expands the light beam in the same direction the mirror focuses said light beam.

16. A bar code reader comprising:
a bar code reader housing having a housing interior;
a light transmitting window and which extends across a portion of the housing;
image capturing means positioned relative to the light transmitting window within said housing interior for capturing a bar code image; and
illumination means for emitting an illumination/aiming pattern of light from the housing interior to a bar code target object spaced from the housing comprising:
i) source means for emitting light to pass through a region of the scanner housing;
ii) slit means positioned relative to the illumination source for forming an elongated pattern of light from light emitting from the source means;
iii) deflection means having a curved surface positioned within the housing for reflecting and shaping light from the slit means; and
iv) lens means having toroidal entrance and exit surfaces for redirecting light from the deflection means through the light transmitting window in the housing in an elongated pattern at a bar code reader focal distance.

17. The bar code reader of claim 15 wherein the toroidal entrance and exit surfaces bend light by differing amounts in a sagittal and a tangential direction.

18. A bar code reader comprising:
a bar code reader housing having a housing interior;
a light transmitting window which extends across a portion of the housing;
image capturing system positioned relative to the light transmitting window within said housing interior for capturing a bar code image; and
an illumination assembly for emitting an illumination/aiming pattern of light from the housing interior to a bar code target object spaced from the housing comprising:
i) an illumination source energizable to emit an elongated pattern of light;
ii) a mirror having a curved reflecting surface positioned within the housing to reflect light passing through the slit aperture and to focus the light in a first direction; and
iii) a lens for transmitting light received from the mirror and cause the light to diverge in a first direction, and converge in a direction orthogonal to the first direction, and pass through the light transmitting window of the housing.

19. The bar code reader of claim 17 wherein the mirror is oscillatory that it scans incident light beam vertically across a barcode.
